(19) United States
(12) Patent Application Publication
(10) Pub. No.: US 2011/0095089 A1
(43) Pub. Date: Apr. 28, 2011

(54) ELECTRONIC TAG HOUSING HAVING CABLE TIE SUPPORT

(75) Inventors: Chester Kolton, Westfield, NJ (US); Michael Norman, East Brunswick, NJ (US); Jacob Strassburger, South Plainfield, NJ (US)

(73) Assignee: B&G PLASTICS, INC., Newark, NJ (US)

(21) Appl. No.: 12/885,725

(22) Filed: Sep. 20, 2010

Related U.S. Application Data
(60) Provisional application No. 61/255,530, filed on Oct. 28, 2009.
(60) Provisional application No. 61/288,890, filed on Dec. 22, 2009.

(51) Int. Cl. G06K 19/077

(52) U.S. Cl. 235/492

(57) ABSTRACT

The present invention provides for an electronic tag housing used to support electronic tags to an article with a pair of cable ties. The present invention provides an electronic tag assembly, including a housing having a base and a cover attachable to the base. The housing includes a cavity for supporting an electronic tag. At least one cable tie is supported by the housing.

### CROSS-REFERENCE TO RELATED APPLICATION

This application claims priority to U.S. Provisional Patent Application No. 61/255,530, filed on Oct. 28, 2009, and U.S. Provisional Patent Application No. 61/288,890, filed on Dec. 22, 2009, which is incorporated herein by reference.

### FIELD OF THE INVENTION

The present invention is relates to an electronic tag housing used to support electronic tags. More particularly, the present invention relates to an electronic tag housing which may be supported to an article with a cable tie.

### BACKGROUND OF THE INVENTION

It is widely known to use electronic tags for various purposes. Such electronic tags may include article surveillance (EAS) tags as well as radio frequency identification (RFID) tags. RFID tags are commonly used to track the articles to which they are attached for purposes of tracking sales and shipment of the article. EAS tags may be used to provide theft deterrents. These tags are used in combination with an alarm system which monitors undesired movement of the article containing the EAS tag.

Housings have been developed which accommodate the electronic tag and which attach the tag to the desired article. Clearly, especially with the case of article surveillance tags to deter theft, it is necessary that the tag be securely supported to the article in such a manner where it remains with the article until the time of purchase. The art has seen a number of tag housings which secure the tag to the article in a manner which thwarts the unauthorized removal of the tag from the housing. However, many of these tags become difficult to remove even by authorized personnel. For example, at the point of sale, the sales person must use specialized tools and equipment to safely remove the tag housing from the article once it has been purchased.

One housing which supports an article surveillance tag to products such as eyeglasses is shown and described in U.S. Pat. No. 6,330,758. The product described therein employs a shrink wrap tube which is attachable to the tag housing. The tube may be slid over the temple arm piece of the eyeglass frame and then shrunk thereon by application of heat. At the point of purchase, the tag housing may be removed by cutting the shrink wrap tube from the article.

The product described in the above-referenced patent, while adequate for its intended purpose, is not without disadvantages. For example, the shrink wrap tube must be inserted within a slot formed on the housing. Such arrangement does not securely attach the tube to the housing prior to shrinking the tube on the article. Further, the shrink wrap requires heat to secure it to the article. The heat may harm the article. Furthermore, since the shrink wrap tube is ultimately shrunk onto the article itself, cutting the shrink wrap tube from the article without damaging the article is difficult.

It is, therefore, desirable to provide an improved tag housing which supports an electronic tag and a fastening system to an article where the fastening system is adjustable and securely supported on the housing and can be removed by authorized personnel in a cost effective and safe manner.

### SUMMARY OF THE INVENTION

The present invention provides an electronic tag assembly, including a housing, having a base and a cover attachable to the base. The housing includes a cavity for supporting an electronic tag. A pair of cable ties sandwiched between the base and the attachable cover. The pair of cable ties also extend though the base.

Additionally, the present invention includes an electronic tag assembly for attachment to an elongate article including a tag housing and a pair of cable ties. The tag housing includes a base and a cover. The housing supports an electronic tag. The pair of cable ties is supported by either side of the base and the pair of cable ties is sandwiched between the base and the cover. The base includes an elastomeric element in facing opposition to a portion of the pair of cable ties and defining therebetween an insertion channel for insertably receiving the elongate article. The cover includes a hook extending therefrom for attachment of the tag housing to a display rack.

Further, the present invention provides an electronic tag assembly, including a housing, having a base and a cover attachable to the base. The base includes a hook at one end. The housing includes a cavity for supporting an electronic tag. A cable tie extends through the base to secure an article to the tag housing.

Additionally, the present invention includes an electronic tag assembly for attachment to an elongate article including a tag housing and a cable tie. The tag housing includes a base and a cover. The housing supports an electronic tag. The cable tie is supported by the base and the cable tie extends through the base. The base includes an elastomeric element in facing opposition to a portion of the cable tie and defining therebetween an insertion channel for insertably receiving the elongate article. The base includes a hook extending from one end of the base for attachment of the tag housing to a display rack.

### BRIEF DESCRIPTION OF THE DRAWINGS

FIGS. 1-3 show a first embodiment of an electronic tag assembly of the present invention including a housing supporting an electronic tag and a pair of cable ties.

FIGS. 4-6 show a base of the electronic tag assembly of FIG. 1.

FIGS. 7-9 show a cover of the electronic tag assembly of FIG. 1.

FIGS. 10-12 show a hooked cover of the electronic tag assembly of a second embodiment.

FIGS. 13-15 show a second embodiment of an electronic tag assembly of the present invention including a housing supporting an electronic tag and a pair of cable ties including the hooked cover of FIG. 10.

FIGS. 16-20 show an electronic tag assembly of the present invention including a housing supporting an electronic tag therein and a cable tie extending thereabout.

FIGS. 21-22 show a base of the electronic tag assembly of FIG. 16.

### DETAILED DESCRIPTION OF THE PREFERRED EMBODIMENTS

The present invention provides a tag housing assembly including a housing which supports an electronic tag, for example, an electronic article surveillance (EAS) tag or radio frequency identification (RFID) tag. The housing is attachable to an article so as to maintain the tag with the article to track shipment, purchase and/or to provide theft deterrence.

The housing of the present invention supports a pair of cable ties which may be placed over an article or portion of an article, and tighten thereabout to secure the housing to the article. The cable ties may be severed to effect removal of the housing from the article. While the housing may be used in combination with any desired article, the present invention is particularly useful with articles having elongate segments such as eyeglasses and paint brushes.

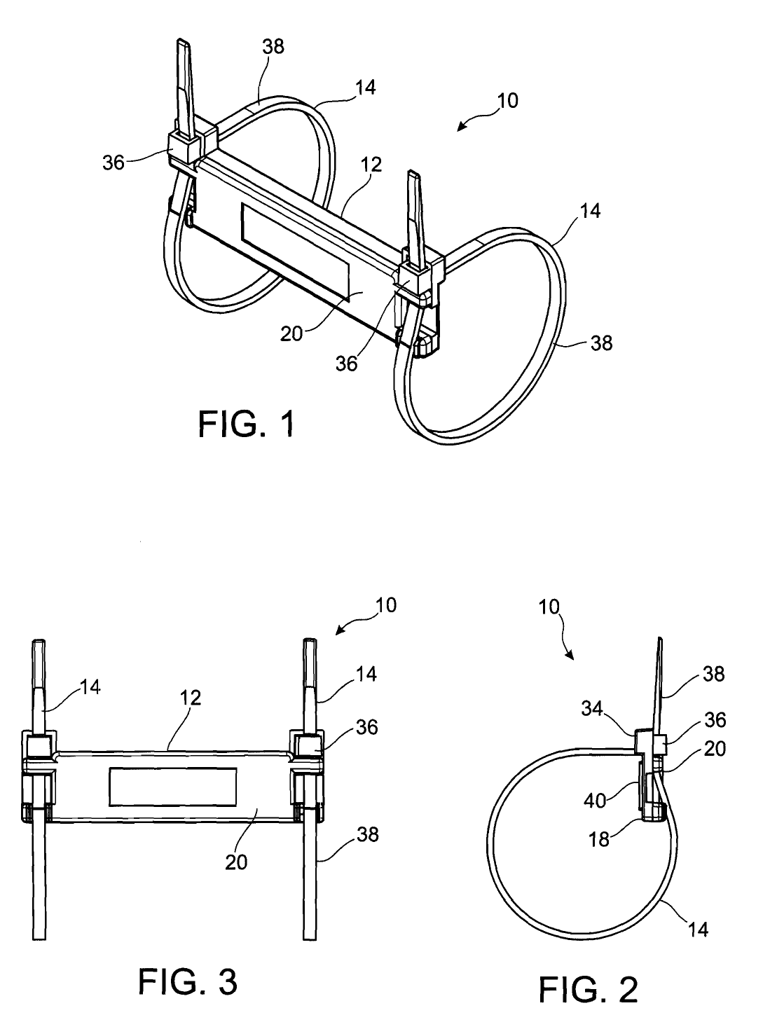

Referring to FIGS. 1-7, one embodiment of the tag housing assembly of the present invention is shown. FIGS. 1-3 show tag housing assembly 10 including a tag housing 12, an electronic tag 16 supported by the housing 12, and a pair of cable ties 14 extending about the housing 12.

In the present illustrative embodiment, tag 16 is an elongate generally rectangular planar member which may function as an EAS tag or an RFID tag as is well known in the art. Other configurations and types of electronic tags are also contemplated within the scope of the present invention.

Tag housing 12 is generally an elongate planar shaped two-piece member including a base 18 and cover 20. The base 18 may include an elongate cavity 22 formed therein. Cavity 22 is configured to accommodate tag 16 therein.

Cover 20 is positionable over base 18 and is attached thereto to cover and enclose the tag 16 within the cavity 22 of base 18. The cover 20 may be secured to base 18 by any well known attachment technique such as friction fit, adhesive, ultrasonic welding and the like.

Each of the cable ties 14 includes a head 36 and a tail 38 extending from the head 36, and is made from conventional construction. The tail 38 is a thin planar band that extends through the opening 32 and loops around the tag housing 12. The tail 38 extends into an opening in the head 36 which allows for entry in one direction but does not allow for removal in the opposing direction. The cable tie 14 is designed to receive an article or portion of an article to which the tag housing is to be secured, such that upon threading of the tail 38 through the head 36, the cable tie 14 will tighten about the article and secure the tag housing 12 to the article.

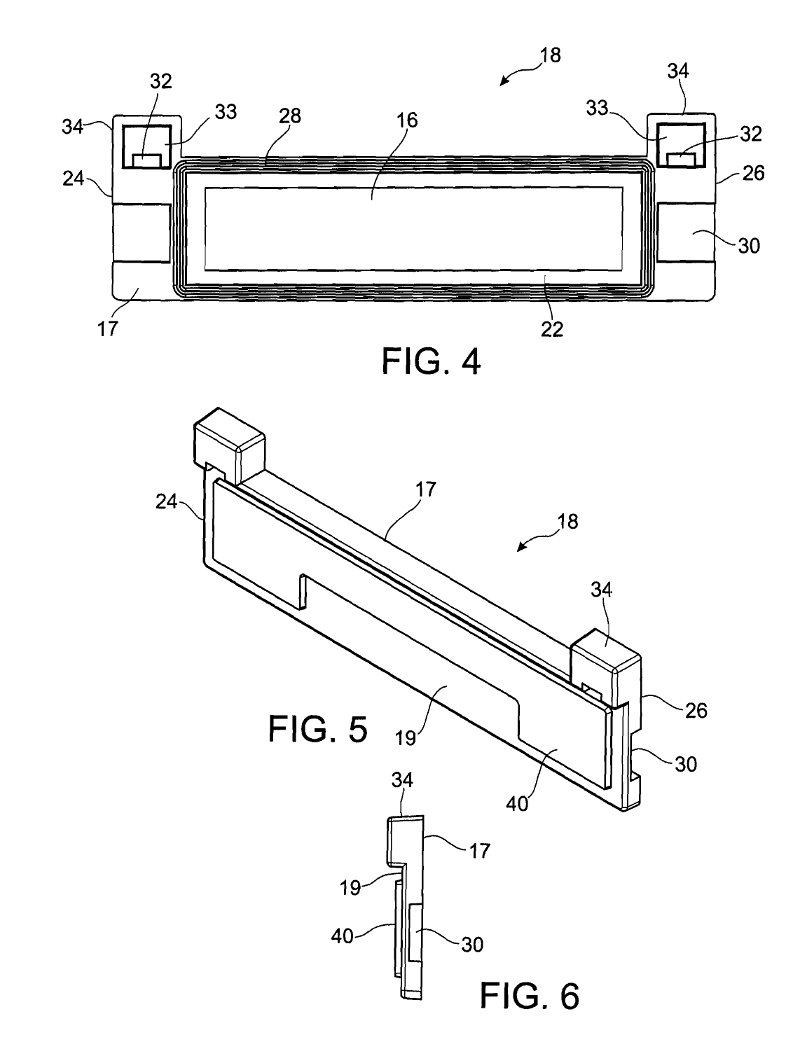

As more fully shown in FIGS. 4-6, base 18 is generally U-shaped and has a front surface 17 and a back surface 19. The base 18 includes a generally rectangular center cavity 22 extending between a pair of elongate opposed side panels 24 and 26. The cavity 22 is surrounded about the perimeter with a rim 28 which is designed to engage with the cover 20 and seal the tag 16 within. The side panels 24, 26 are generally rectangular extensions where a portion extends upwardly forming the legs of the U-shape of the base 18. Each side panel 24, 26 provides a technique for allowing authorized personnel to remove the tag housing from the article after the pair of cable ties 14 have been tightened onto the article. Each side panel 24, 26 has a depression 30. Depression 30 underlies the cable ties 14 and forms a cut slot. The cut slot formed by depression 30 defines a passageway for insertion of scissors or a blade of a cutting tool so as to cut the cable tie 14 thereby severing the tag housing from the article. The depression 30 allows such insertion of a cutting tool thereinto without damaging or contacting the article.

Each side panel 24, 26 includes an opening 32 therethrough for one cable ties 14 to extend therethrough and engage the base 18. Further, FIGS. 5 and 6 show a pocket 34 which is generally a square-shaped three-sided box protruding out the rear surface 19 of the base 18. Opening 32 is located within the pocket 34. FIG. 1 shows the pocket 34 is a cavity that can receive the head 36 of the cable tie 14. The pocket cavity is accessible through the open face 33 of the pocket 34 which is accessible from the front surface 17 of the base 18, as shown in FIG. 4.

To assure that the cable ties 14 tighten closely about the article, the base 18 includes an insulated pad 40 attached to the rear surface 19, as shown in FIG. 5. The rear surface 19 of the base 18 is in contact with and against the surface of the article of which it is attached. The pad 40 protects the article which the housing assembly 10 is attached to and provides added friction to prevent unauthorized removal of the assembly 10 from the article. The pad 40 is preferably made of a thermoplastic rubber. The tag housing assembly 10 will be difficult to remove from the article after tightening of the cable tie 14.

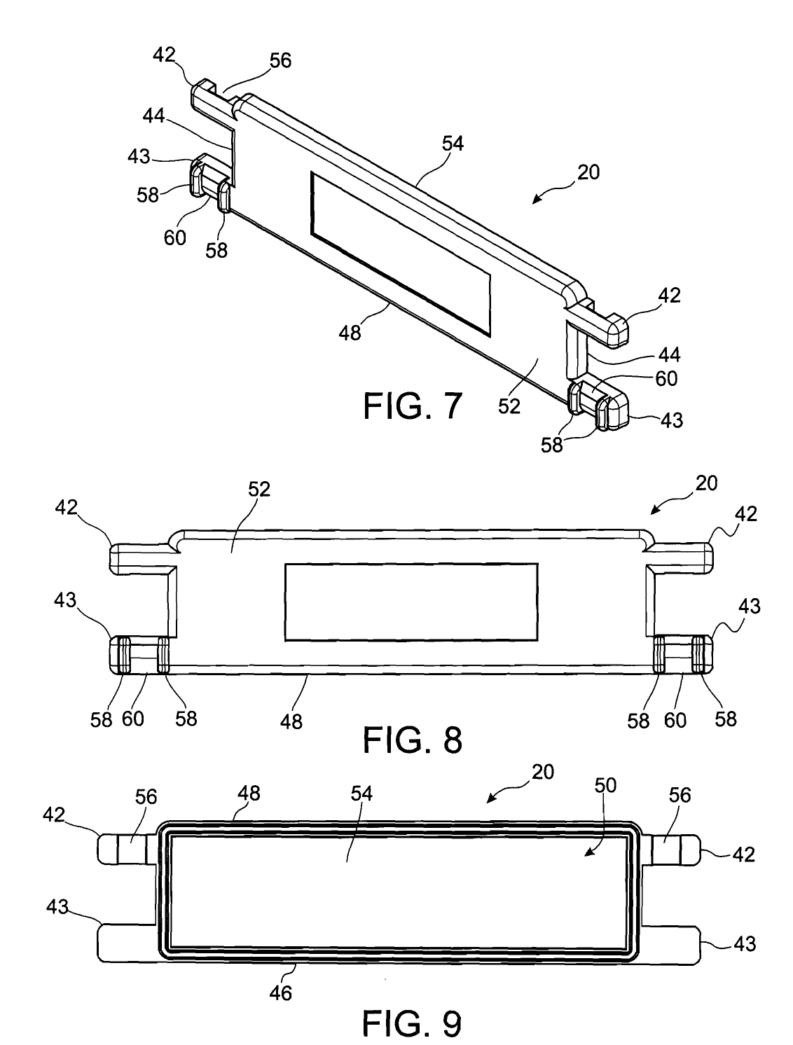

As more fully shown in FIGS. 7-9, cover 20 is generally rectangular in shape with two pairs of projecting tabs (42, 43) from opposing sides 44 of the cover 20. The cover 20 includes a front surface 52 and a rear surface 54. The projecting tabs 42, 43 provide for guidance and ease of cutting of the cable tie 14. The center section 48 of the cover 20 includes a raised rim 46 protruding from the front surface 52. The rim 46 extends about the perimeter of the center section 48 and the rim 46 is slightly inset from the perimeter of the center section 48 defining a cover cavity 50 for the electronic tag 16 to seat. The rim 46 provides a surface for attachment of the base 18 to the cover 20. The first pair of projecting tabs 42 extends collinear with the second pair of projecting tabs 43. The projecting tabs 42, 43 are spaced apart from each other. The first pair of projecting tabs 42 includes a cut out channel 56 from the rear surface 54 of the cover 20. The channel 56 guides the cable tie 14 such that the cable tie 14 is sandwiched between the channel 56 and the pocket 34 of the base 18, as shown in FIG. 1. Each second pair of projecting tabs 43 is planar on the rear surface 54 and includes a pair of parallel extending ridges 58 protruding from the front surface 52. The pair of parallel extending ridges 58 defines a U-shaped channel for accepting the cable tie 14 therein. The surface extending between the ridges 58 is beveled to provide a raised surface 60 for the cable tie 14 to deflect off of assisting with cutting of the cable tie, as shown in FIG. 2.

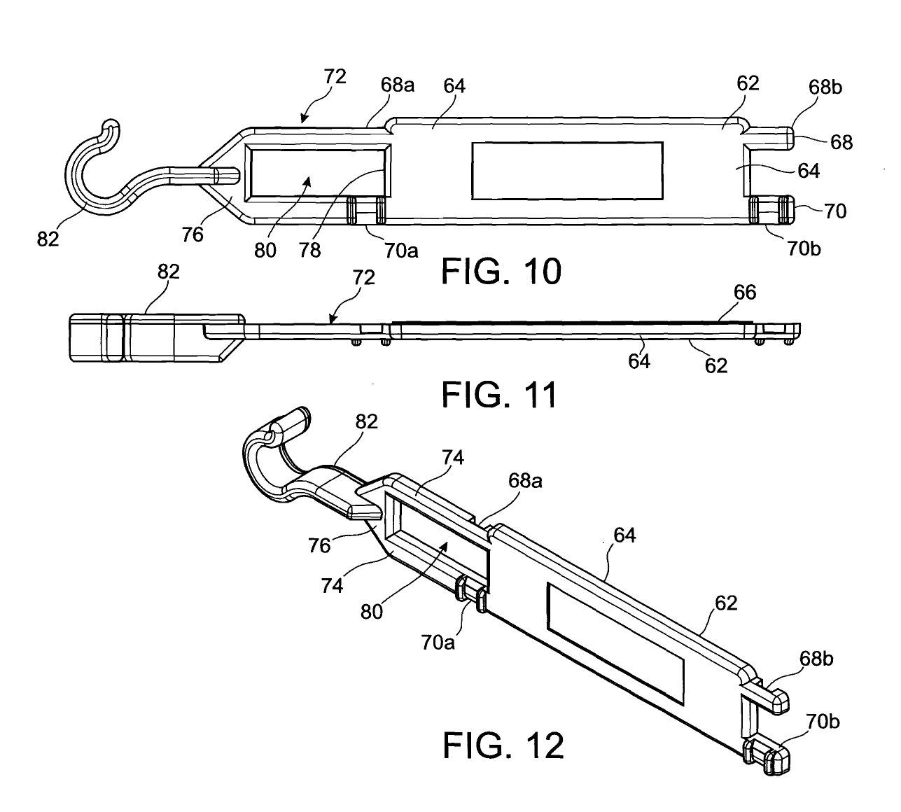

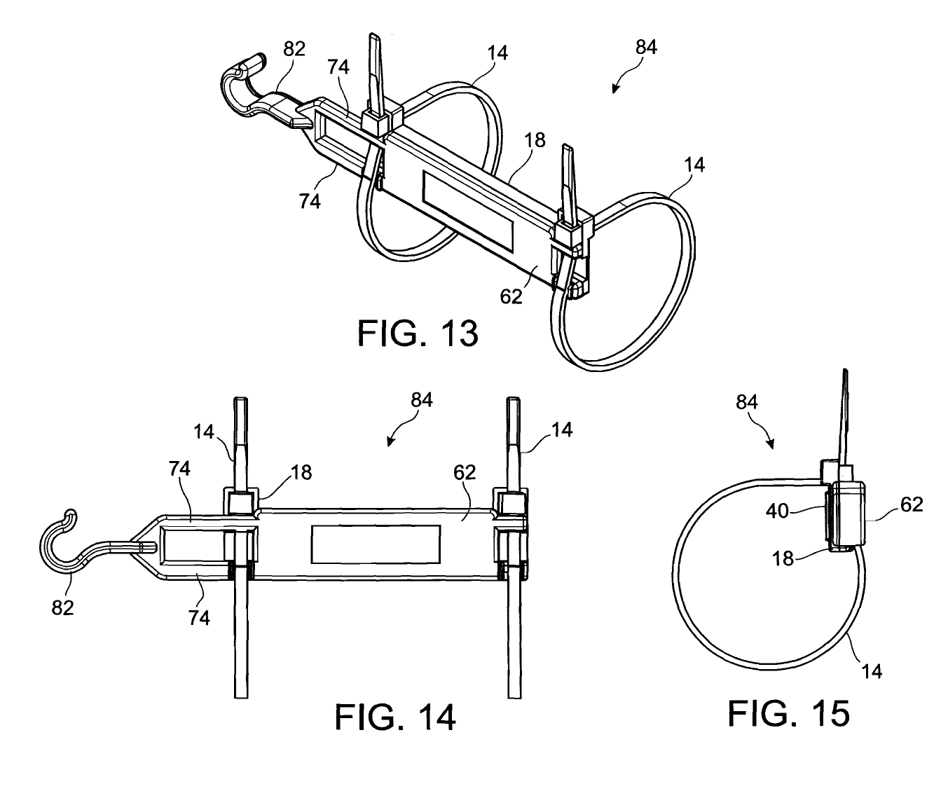

A further embodiment of the present invention is shown with respect to FIGS. 10-15. Tag housing assembly 84 is substantially similar to tag housing 10 described above. Tag housing assembly 84 includes base 18 with a hooked cover 62 and a pair of cable ties 14. The hooked cover 62 is similar to cover 20 including a center section 64 with a raised rim 66 about the perimeter which is inset from the edges of the center section 64, and two pairs of projecting tabs 68, 70. FIG. 12 shows the short projecting wings 68b, 70b are similar to the projecting wings 42 and 43 of FIG. 8, respectively. Longer projecting wings 68a and 70a are similar to the projecting wings 42 and 43 of FIG. 8 with a hook attachment 72 extending therefrom. The hook attachment 72 is formed from the cover 62. The hook attachment 72 is a continuous extension from the cover 62 and projecting wings 68a, 70a. The hook attachment 72 includes a pair of parallel longitudinal extents 74 extending from each wing 68a, 70a. A connector portion 76 attaches the pair of longitudinal extents 74, such that the connector portion 76 and longitudinal extents 74 have a U-shaped geometry. Additionally, the longitudinal extents 74, connector portion 76 and the side of the center section 78 define an opening 80 therethrough. Extending from the connector portion 76, in the opposite direction as the longitudinal extensions 74 is a hook 82. The hook 82 is in the same plane as the connector portion 76, but the hook 82 is twisted such that the hook 82 is perpendicular the connector portion 76 and center section 78, as shown in FIG. 13. The hook 82 provides a mechanism to hang the article that is attached to the assembly 84.

The tag 16 is placed between the hook cover 62 and the base 18. The hooked cover 62 and the base 18 are attached together by use of welding or adhesive, or other mechanical means. The cable ties 14 extend through the base 18, about an article, around the base 18 and through the cover 62. The cable ties 14 are sandwiched between the cover 62 and base 18, specifically between side panels 24, 26 and projecting wings 68, 70. The cable ties 14 are inserted into the cable ties head 36, and the head of the cable tie 36 seat within the pocket 34 of the base 18, as shown in FIGS. 13-15.

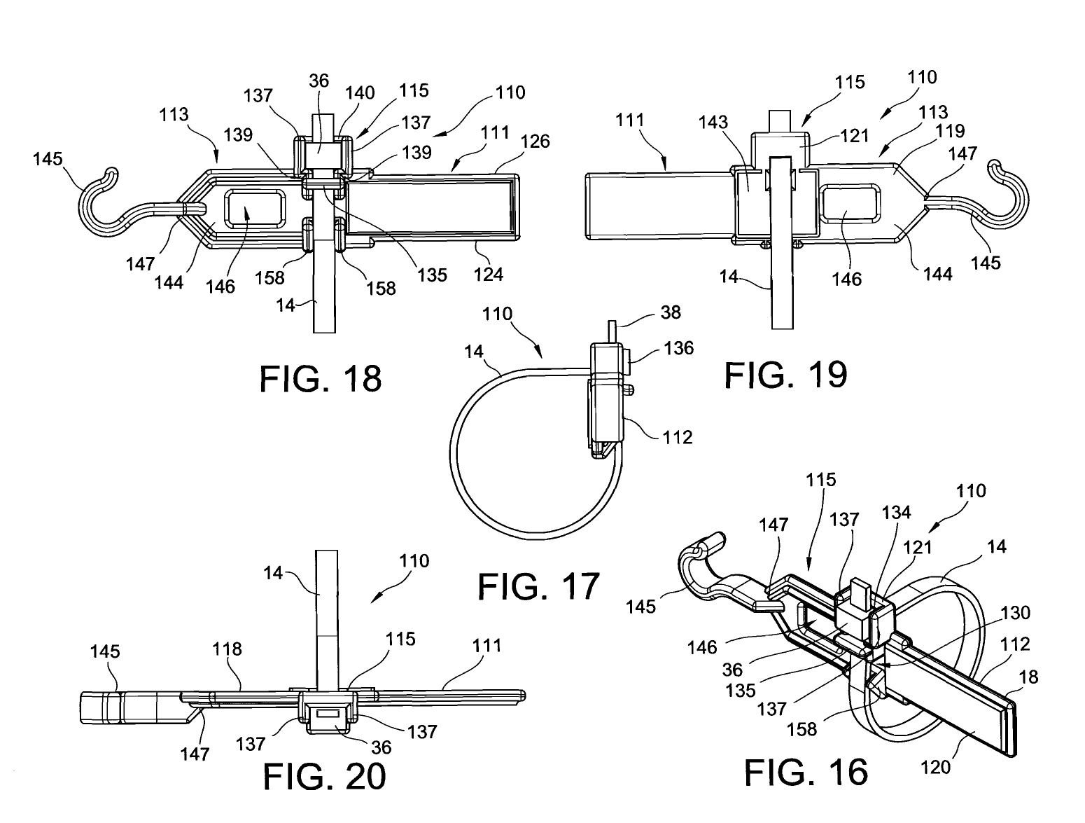

Referring to FIGS. 16-22, one embodiment of the tag housing assembly of the present invention is shown which is similar to tag housing assembly 84. The tag housing assembly 110 includes a tag housing 112, an electronic tag 16 supported by the housing 112, and a cable tie 14 extending about the housing 112.

Tag housing 112 is generally an elongate planar shaped two-piece member including a base 118 and cover 120. The base 118 may include an elongate cavity 122 formed therein. Cavity 122 is configured to accommodate tag 16 therein, as shown in FIG. 6.

FIG. 16 shows cover 120 is positionable over base 118 and is attached thereto to cover and enclose the tag 16 within the cavity 122 of base 118. The cover 120 may be secured to base 118 by any well known attachment technique such as friction fit, adhesive, ultrasonic welding and the like. The cable tie 14 extends through opening 132 and loops around housing 112 to secure article to housing 112.

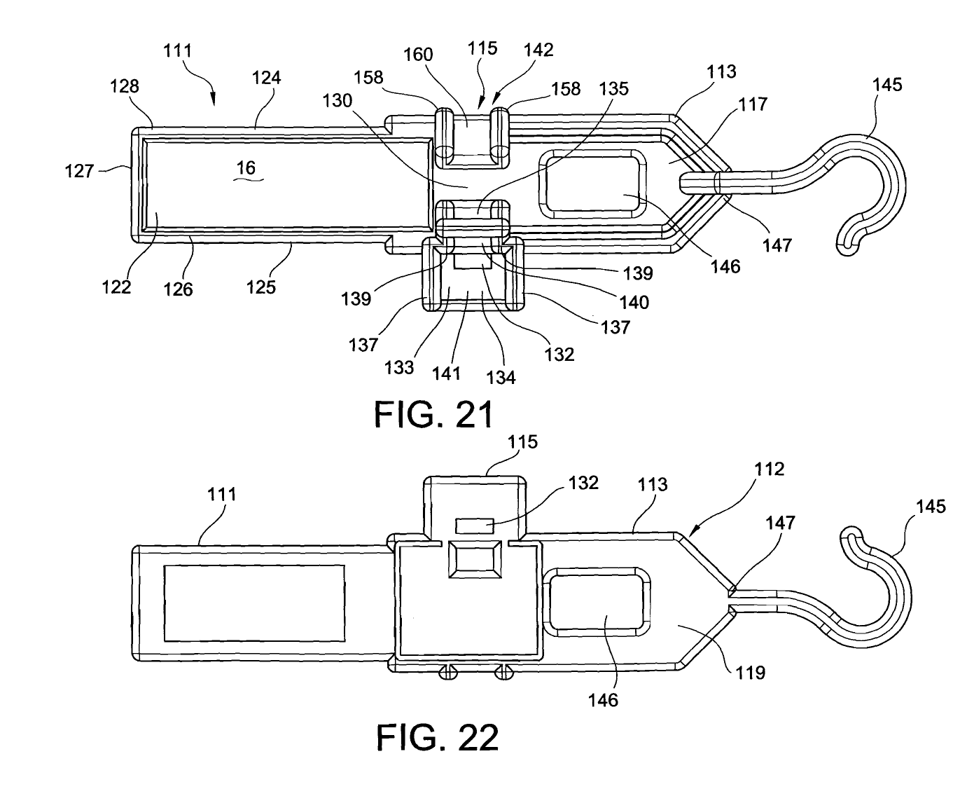

As more fully shown in FIGS. 21-22, base 118 is generally an elongated planar pentagon with a hook 162 extending from one end. The base 118 has a front surface 117 and a back surface 119. The base 118 includes a tag receiving area 111, a hook attachment portion 113 and a cable tie fastener portion 115 extending therebetween. The tag receiving area 111 is a generally rectangular cavity 122 extending between a pair of elongate opposed sides 124 and 126, and between an end 127 and tag receiving area 111. The cavity 122 is surrounded about the perimeter with a rim 128 which is designed to engage with the cover 120 and seal the tag 16 within.

The base 118 includes a protruding portion 121 which is a rectangular protrusion extending from one side 124 of the base 118. The protruding portion 121 is planar on the back surface 119 of the base 118 and forms a pocket 134 on the front surface 117. FIGS. 16 and 21 show a pocket 134 which is generally a square-shaped three-sided box protruding out the front surface 119 of the base 118. Below the pocket 134 is a U-shaped band 135 which strikes out from the front surface 117 of the base 118 and allows for a cable tie 14 to extend between the band 135 and the front surface 117. FIGS. 16, 18 and 21 show a U-shaped channel 142 in alignment with the protruding portion 121 but the U-shaped channel 142 extends from the other side 125 of the base 118. The U-shaped channel 142 is angled, such that it is extending from the edge of side 125 to provide for securement of the cable tie therein. The U-shaped channel 142 includes a pair of parallel extending ridges 158 protruding from the front surface 117. The pair of parallel extending ridges 158 defines a U-shaped channel for accepting the cable tie 14 therein. The surface extending between the ridges 158 is beveled to provide a surface 160 for the cable tie 14 to deflect off from, and assist with cutting of the cable tie 14, as shown in FIG. 21.

Between the U-shaped channel 142 and the pocket 134 is a recessed surface defining a depression 130. Depression 130 underlies the cable ties 14 and forms a cut slot. The cut slot formed by depression 130 defines a passageway for insertion of scissors or a blade of a cutting tool so as to cut the cable tie 14 thereby severing the tag housing from the article. The depression 130 allows such insertion of a cutting tool thereinto without damaging or contacting the article to allow authorized personnel to remove the tag housing from the article after the cable tie 14 has been tightened onto the article.

FIG. 22 shows the pocket 134 includes a cavity that can receive the head 36 of the cable tie 14. The pocket 134 includes a pair of sidewall 137. The sidewalls 137 include a shortened wall 139 extending perpendicularly from each sidewall 137. Each shortened wall 139 extends from the sidewall 137 and towards the other shortened wall 139 defining a partial sidewall 140. There is a space between the shortened walls 139 to allow a cable tie 114 to extend between the shortened walls 139. The pocket cavity 141 is accessible through the open face 133 of the pocket 134 which is accessible from the front surface 117 of the base 118. The pocket 134 includes an opening 132 located within the cavity 141 which extends through the base 118 to allow a cable tie 14 to extend therethrough, as shown in FIGS. 16-20.

To assure that the cable ties 14 tighten closely about the article, the base 118 includes an insulated pad 143 attached to the back surface 119, as shown in FIG. 19. The back surface 119 of the base 118 is in contact with and against the surface of the article of which it is attached. The pad 143 protects the article which the housing assembly 110 is attached to and provides added friction to prevent unauthorized removal of the assembly 110 from the article. The pad 143 is preferably made of a thermoplastic rubber. The tag housing assembly 110 will be difficult to remove from the article after tightening of the cable tie 14.

The hook attachment portion 113 extends from the cable tie fastener portion 115. The hook attachment portion 113 includes a hexagonal planar extension 144 and a hook 145. The hexagonal extension 144 is sandwiched between the cable tie fastener portion 115 and the hook 145. The hook 145 is in the same axis plane as the hexagonal planar extension 144, but the hook 145 is twisted such that the hook 145 is perpendicularly connected to the hexagonal planar extension 144, as shown in FIGS. 16 and 20. The hook 145 provides a mechanism to hang the article that is attached to the housing assembly 110. The hook 145 is attached to the hexagonal planar extension 144 at the peak 147 of the hexagonal planar extension 144. The hexagonal planar extension 144 includes an opening 146 extending through the center of the hexagonal planar extension 144.

The tag 16 is placed between the cover 120 and the base 118. The cover 120 and the base 118 are attached together by use of welding or adhesive, or other mechanical means. The cable tie 14 extends through the base 118 at the cable tie fastener portion 115, about an article and around the base 118. Specifically, the head of the cable tie 136 seats within the pocket 134 of the base 118 and the tail of the cable tie 14 extends through the opening 132 in the pocket 134. The cable tie 14 extends about the back surface 119 of the tag housing 112 securing the article between the back surface 119/friction pad 143 and the cable tie 14. The cable tie 14 tail 38 extends within the U-shaped channel 142 between the ridges 158 on the front surface 117, under the band 135 and through the head 36 of the cable tie 14, as shown in FIGS. 16-20.

Various changes to the foregoing described and shown structures would now be evident to those skilled in the art. Accordingly, the particularly disclosed scope of the invention is set forth in the following claims.

What is claimed is:

1. An electronic tag assembly comprising:
a tag housing including a base and a cover attachable to said base and defining a tag receiving cavity;
an electronic tag supported within said cavity; and
at least one a cable tie extending about said tag housing to secure an article to said tag housing.

2. The electronic tag assembly of claim 1 wherein said base includes a hook attached to one end of said base.

3. The electronic tag assembly of claim 1 wherein said cable tie extends through said base defining a cable tie portion, said cable tie portion is sandwiched between said tag receiving cavity and said hook.

4. The electronic tag assembly of claim 3 wherein said cable tie portion includes a depression which underlie said cable tie to allow for insertion of a cutting tool for removal of said tag assembly.

5. The electronic tag assembly of claim 3 wherein said cable tie portion includes an opening therethrough for said cable tie to extend through said base,

6. The electronic tag assembly of claim 5 wherein said cable tie portion includes a pocket to seat a head of said cable tie therein, wherein said pocket includes said opening therethrough for said cable tie to extend through said base.

7. The electronic tag assembly of claim 6 wherein said cable tie portion includes a band wherein said band strikes out from a surface of said base, said cable tie is sandwiched between said band and said base.

8. The electronic tag assembly of claim 7 wherein said cable tie portion includes a pair of spaced apart parallel ridges extending from a surface of said base to allow said cable tie to extend therebetween.

9. The electronic tag assembly of claim 8 wherein a surface between said pair of ridges is beveled.

10. The electronic tag assembly of claim 1 wherein said hook is attached perpendicularly to said base.

11. An electronic tag assembly comprising:
a tag housing including a base and a cover attachable to said base and defining a tag receiving cavity;
an electronic tag supported within said cavity; and
a pair of cable ties sandwiched between said base and said attachable cover and extending though said base.

12. The electronic tag assembly of claim 11 wherein said base includes a rectangular center extending between a pair of elongated opposed side panels.

13. The electronic tag assembly of claim 12 wherein each of said side panels include a depression which underlie said pair of cable ties allowing for insertion of a cutting tool for removal of said tag assembly.

14. The electronic tag assembly of claim 11 wherein each if said side panels includes a pocket to seat a head of said pair of cable tie therein, each of said pockets include an opening therethrough for said pair of cable ties to extend through said base.

15. The electronic tag assembly of claim 11 wherein said cover includes a rectangular center with a pair of projecting tabs extending from opposing sides of said cover.

16. The electronic tag assembly of claim 15 wherein each of said pair of projecting tab includes a first tab and a second tab, wherein said first tab is spaced apart from said second tab.

17. An electronic tag assembly of claim 16 wherein said second tab includes a pair of spaced apart parallel ridges extending from a surface of said second tab.

18. The electronic tag assembly of claim 11 further including a hook extending from said cover.

19. The electronic tag assembly of claim 18 wherein said cover includes a rectangular center with a pair of projecting tabs extending from opposing sides of said cover, said hook extending from said projecting tabs on one of said opposing sides.

20. An electronic tag assembly for attachment to an elongate article comprising:
a tag housing including a base and a cover, said housing supporting an electronic tag; and
a pair of cable ties supported by either side of said base and said pair of cable ties sandwiched between said base and said cover;
said base including an elastomeric element in facing opposition to a portion of said pair of cable ties and defining therebetween an insertion channel for insertably receiving said elongate article; and
said cover including a hook extending therefrom for attachment of said tag housing to a display rack.
